(19) United States
(12) Patent Application Publication
(10) Pub. No.: US 2010/0072723 A1
(43) Pub. Date: Mar. 25, 2010

(54) Adjustable Over Tube Anti Roll Bar

(76) Inventor: Andrew Ciasulli, Bangor, PA (US)

Correspondence Address: MITCHELL A. SMOLOW, 720 HAMPTON ROAD, SHAVERTOWN, PA, 18708, US

(21) Appl. No.: 12/564,230

(22) Filed: Sep. 22, 2009

Related U.S. Application Data
(60) Provisional application No. 61/194,111, filed on Sep. 24, 2008.

(51) Int. Cl. B60G 21/055

(52) U.S. Cl. 280/124.106

(57) ABSTRACT

An anti roll bar assembly is provided having opposing over tubes that are fixed to a torsional spring at both ends. The torsional spring is suspended within a main support tube which also rotatably receives each over tube. Torque arms are fabricated to be positioned along each over tube such that an inter torque arm width is less than a torsional spring length.

### CROSS REFERENCE TO RELATED APPLICATIONS

This application claims benefit of U.S. Application No. 61/194,111 filed Sep. 24, 2008.

### FIELD OF THE INVENTION

This invention relates generally to vehicle suspensions, and in particular, to an adjustable over tube anti roll bar.

### BACKGROUND OF THE INVENTION

As a vehicle enters a turn, the resulting centrifugal forces acting on the vehicle roll the vehicle body about its roll center relative to the underlying suspension system. This centrifugal force also displaces the body laterally and outwardly, causing the vehicle to pivot about the contact of its outer wheels with the road surface.

Anti-roll bars are used to limit this tendency of moving vehicles to roll or lean while traversing a corner. This is achieved by coupling the left suspension members to the right suspension members using a torsional spring so that relative wheel displacement transmits a torque force to the wheel on the opposite side.

The torsional spring is constrained both radially and axially, and is connected to the moving suspension members by a torque arm and a linkage. The linkage must connect the torque arm to the moving suspension members to transmit the torque force from one side of the vehicle to the other. As this transmission of torque force occurs, the relative torque arms off center distance changes.

Currently, there are two methods to change the torque arms off center distance. The first is to change the length of the torsional spring, by increasing its twist, as torque force is applied, thereby causing the torque arms distance off center to change.

A torsional spring is limited as to the degree it can twist before it fatigues. The longer the torsional spring, the farther it can twist before permanent deformation occurs. If the suspension has a great deal of travel, a relatively short torsional spring will have a greater tendency to over twist with resultant fatigue as it tries to compensate for applied torque force.

The second method of achieving a change to the torque arms off center distance is to use torque arms that have bends inwards towards the centerline. With this method the torque arm mounting points are moved toward the center while maintaining a torsion spring which is longer than the distance between the torque arms. While avoiding the aforementioned disadvantages of a shorter torsion spring, this method is disadvantaged in that it is constrained to a finite offset distance between the torque arms and the torque arm geometry must be bulky in order to withstand the torque component induced by the linkage.

Accordingly, there is still a continuing need for improved anti roll suspension geometry. The present invention fulfills this need and further provides related advantages.

### BRIEF SUMMARY OF THE INVENTION

The present invention provides for anti roll bars having the ability to easily adjust the position of the torque arms along a main support tube thereby providing easy adjustment to meet various mounting widths.

In a first embodiment, an over tube anti roll bar assembly is provided having opposing over tubes that rotationally engage a main support tube at each end. A torsional spring is positioned within the main support tube and extends beyond each end of the main support tube to fixedly and non-rotationally engage the over tubes, thereby suspending the torsional spring within the main support tube. A torque arm is fabricated to slidably and non-rotationally mount onto each over tube at a predetermined position along each over tube such that an inter torque arm width is less than a torsional spring length.

In a second embodiment, each torque arm is fabricated to be an integral part of its respective over tube. In all other respects, the second embodiment is the same as the first.

The present invention also contemplates the method of limiting vehicle roll using the novel over tube anti roll bar assembly.

One advantage of the present invention is that it allows for a torsion spring longer than the width between the torque arms without the need to bend the torque arms.

Another advantage of the present invention is the ability for the torque arms to be easily positioned anywhere along the main support tube allowing for easy adaptation to many different vehicles.

Still another advantage is the ability to move the torque arms along the main support tube, thereby keeping the torque arms in line with the moving suspension components. This results in the omission of torque components required by a bent torque arm making the torque arm lighter and stronger.

Other features and advantages of the present invention will be apparent from the following more detailed description of the preferred embodiments, taken in conjunction with the accompanying drawings which illustrate, by way of example, the principles of the invention.

### BRIEF DESCRIPTION OF THE DRAWINGS

The accompanying drawings are included to provide a further understanding of the present invention. These drawings are incorporated in and constitute a part of this specification, illustrate one or more embodiments of the present invention, and together with the description, serve to explain the principles of the present invention.

FIG. 1 is an exploded isometric view depicting the over tube anti roll bar assembly of the present invention.

FIG. 2 is an isometric view depicting the over tube anti roll bar assembly of FIG. 1.

FIG. 3 is a cut away side view of one side of the over tube anti roll bar assembly.

FIG. 4 is a cut away side view of one side of the over tube anti roll bar with a bushing.

FIG. 5 is a cut away side view of one side of the over tube anti roll bar with an o-ring.

FIG. 6 is an isometric view of the prior art.

FIG. 7 is an isometric view of an alternate embodiment of the present invention.

Other features and advantages of the present invention will be apparent from the following more detailed description of the preferred embodiments, taken in conjunction with the accompanying drawings which illustrate, by way of example, the principles of the invention.

### DETAILED DESCRIPTION OF THE INVENTION

As required, detailed embodiments of the present invention are disclosed; however, it is to be understood that the disclosed embodiments are merely exemplary of the invention that may be embodied in various forms. The figures are not necessary to scale, and some features may be exaggerated to show details of particular components. Therefore, specific structural and functional details disclosed are not to be interpreted as limiting, but merely as a basis for the claims and as a representative basis for teaching one skilled in the art to variously employ the present invention.

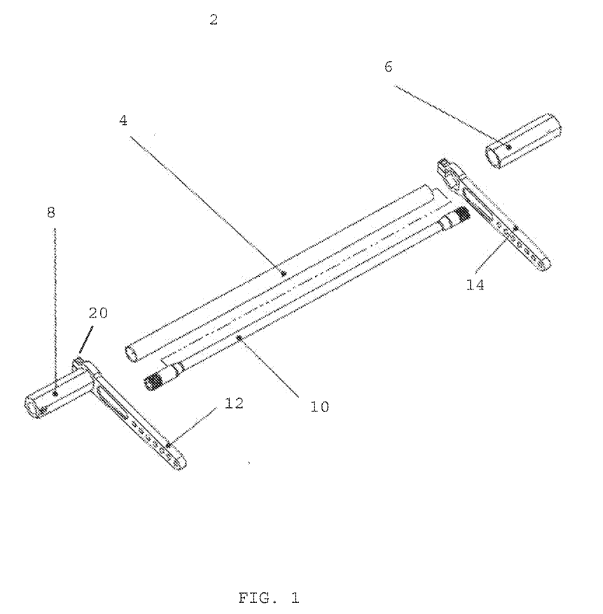

Referring now to the figures, FIG. 1 is an exploded isometric view depicting the over tube anti-roll bar assembly of the present invention. Anti roll bar assembly 2 is comprised of a main support tube 4, over tubes 6 and 8, torsional spring 10, and torque arms 12 and 14.

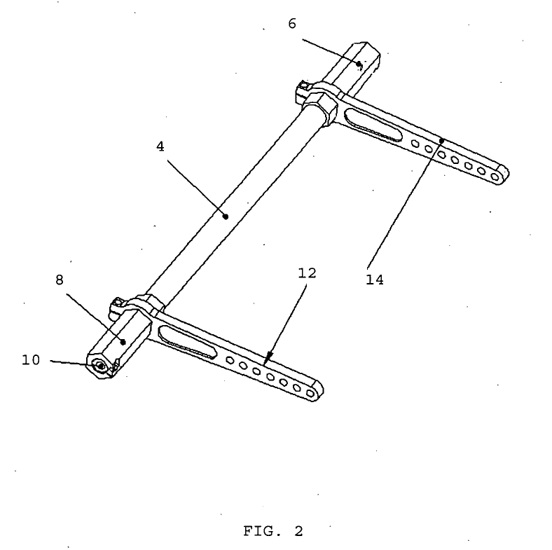

Turning to FIG. 2, anti roll bar main support tube 4 is fixedly mounted to a vehicle (not shown) at, for example behind the front bumper, to the shock mounts, to the A-arm mount, or to any other known anti roll device mounting location. The torsional spring 10 is inserted through the main support tube 4 and suspended therein by attaching the torsion spring ends (22, FIG. 1) into the over tubes 6 and 8 and axially fixing them in any manner that will inhibit relative motion between the torsional spring 10 and the over tubes 6 and 8, for example, by a spline or a mating male/female geometric shape.

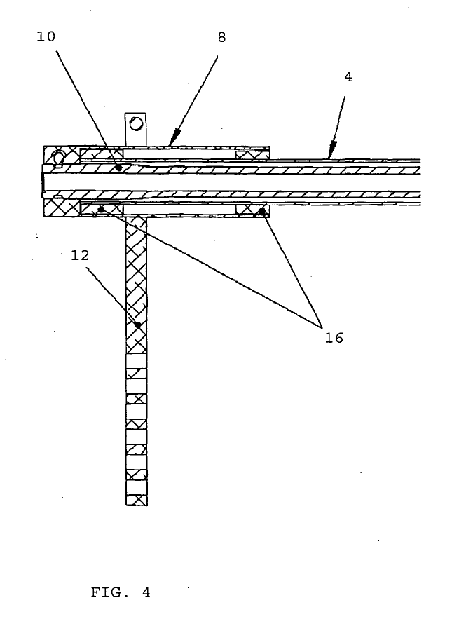

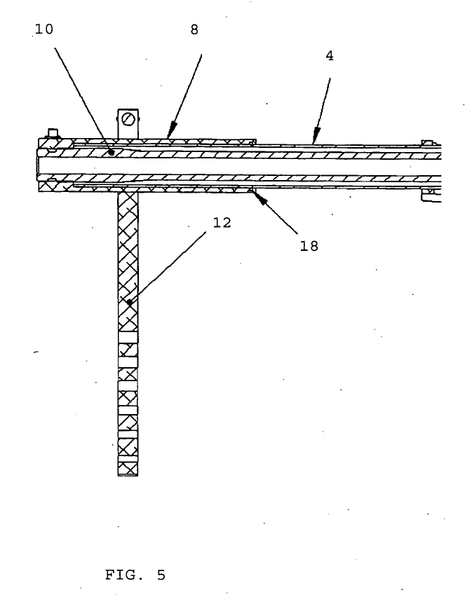

The over tubes 6 and 8 rotate freely over the main support tube 4, for example, by using bushings 16 (FIG. 4), or lubricant, for example, grease, and seal, for example, o-rings 18 to maintain the lubricant within the over tubes 6 and 8 (FIG. 5). The torque arms 12 and 14 are torsionally fixed to the over tubes 8 and 6 in any manner that will inhibit relative motion between the torque arms 12 and 14 and the over tubes 6 and 8, for example, by a spline, a mating male/female geometric shape, or a mating geometric shape and pinch bolt 20. Optionally, the torque arms 12 and 14 may be cast to intimately slide over the geometrically shaped over tubes 6 and 8, thereby avoiding the need for a pinch bolt 20. The intimately cast torque arms 12 and 14 are slid to a predetermined position along the over tubes 8 and 6 to easily adapt for mounting to a mounting location on the vehicle (not shown).

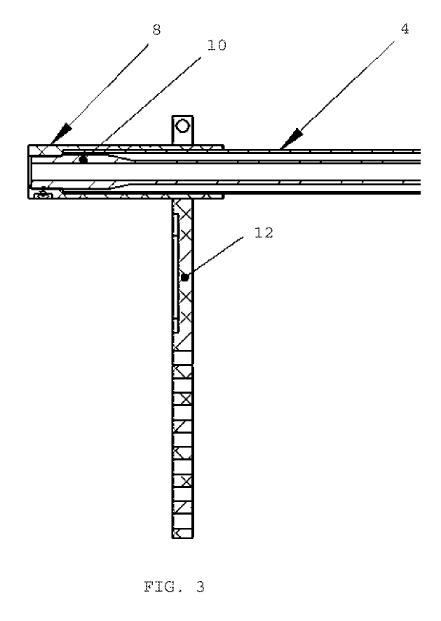

FIG. 3 is a cutaway view of one side of the over tube anti roll bar assembly 2. For convenience, only one side will be described, the opposing side being identical. The torsional spring 10 is a twisting spring, also referred to as torsion bar, of known design and is fixedly inserted into the over tube 8. Such fixation may be, for example, through the use of a mating spline, mating geometric shape, or other known mating techniques. The over tube 8 is free to rotate axially on the main support tube 4, through the use of, for example, grease and o-rings or alternatively, bushings, as described above. Because the torsional spring 10 is suspended and not in contact with the main support tube 4, it requires no additional parts to insure its free rotation within the main support tube 4. The torque arm 12 is slid to a predetermined location along the over tube 8 as described above.

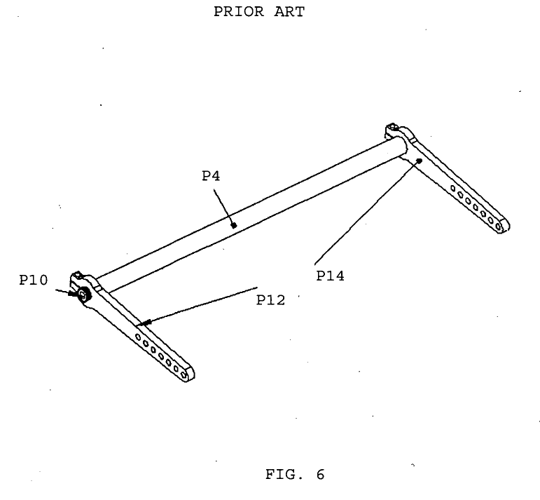

FIG. 6 depicts a prior art design for comparison to the present invention. The torque arms P12 and P14 are fixed to the torsional spring P10 at the ends of tube P4. Torque arms P12 and P14 cannot be positioned anywhere other than at the ends of tube P4 because the novel over tubes 8 and 6 of the present invention are not present.

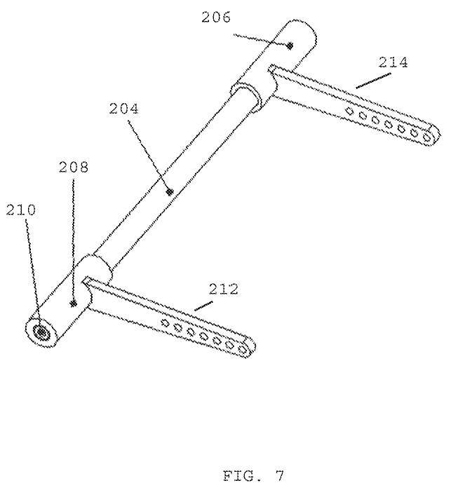

FIG. 7 depicts an alternate embodiment of the present invention in which the torque arms 212 and 214 are fabricated as an integral part of the over tubes 208 and 206. In this manner, the torsion spring 210 may be kept longer than the width between the torque arms 212 and 214 with having to bend the torque arms 212 and 214 inward.

In all embodiments the over tubes are fixed to the torsional spring outside ends. Because the over tubes are free to rotate axially, if one over tube is held in space and torque is applied to the other over tube, torque is transmitted through the torsional spring giving a torsional spring rate between the two over tubes. Because the torque arms are fixed to the over tubes, when a force is applied to a first torque arm, that force is transmitted from the first torque arm to through its over tube to the torsional spring, through the opposite end over tube, and then to the second torque arm, thereby completing the torque transfer from one end of the anti roll bar to the other. The novel over tubes allow fixation of the torque arms to the over tube at any over tube location to transmit torque to the opposing torque arm. In this manner, the fatigue problems of short torsional springs can be avoided.

The novel ability to move the torque arms while keeping the same length torsional spring makes for a more durable design. In this manner the torque arms can be moved inward toward the center of the vehicle so that the torque arm mounts line up with mounts in close to their pivot points without having to shorten the torsional spring. Suspension mounting points that mount closer to the pivot point create less angular displacement of the torsional spring and, therefore, less likelihood for the torsional spring to be over twisted and fatigue.

Although the present invention has been described in connection with specific examples and embodiments, those skilled in the art will recognize that the present invention is capable of other variations and modifications within its scope. These examples and embodiments are intended as typical of, rather than in any way limiting on, the scope of the present invention as presented in the appended claims.

1. An anti roll bar assembly comprising:
a main support tube have opposing ends;
an over tube rotatably received at each opposing end;
a torsional spring suspended within the main support tube, axially fixed at each end to the over tube so as to inhibit relative motion between the torsional spring and the over tube; and
a torque arm slidably fitted and torsional fixed to each over tube so as to inhibit rotative motion between the torque arm and the over tube.

2. The anti roll bar assembly of claim 1 wherein the over tube is axially fixed to the torsional spring using a connection selected from the group consisting of a spline and a male-female geometric shape.

3. The anti roll bar assembly of claim 1 further comprising a bushing between the over tube and the main support tube.

4. The anti roll bar assembly of claim 1 further comprising a lubricant placed between the over tube and the main support tube and a seal to maintain the lubricant within the over tube.

5. The anti roll bar assembly of claim 1 wherein the torque arm is torsionally fixed to the over tube using a connection selected from the group consisting of a spline, a male-female geometric shape, and mating geometric shapes with pinch bolt.

6. The anti roll bar assembly of claim 1 wherein the torsional spring is a twisting spring.

7. The anti roll bar assembly of claim 1 wherein an inter torque arm width is less than a torsional spring length without bending the torque arms towards each other.

8. An anti roll bar assembly comprising:
a main support tube have opposing ends;
an over tube rotatably received at each opposing end; and
a torsional spring suspended within the main support tube, axially fixed at each end to the over tube so as to inhibit relative motion between the torsional spring and the over tube;
wherein each over tube further comprises an integrally formed torque arm.

9. The anti roll bar assembly of claim 8 wherein the over tube is axially fixed to the torsional spring using a connection selected from the group consisting of a spline and a male-female geometric shape.

10. The anti roll bar assembly of claim 8 further comprising a bushing between the over tube and the main support tube.

11. The anti roll bar assembly of claim 8 further comprising a lubricant placed between the over tube and the main support tube and a seal to maintain the lubricant within the over tube.

12. The anti roll bar assembly of claim 8 wherein the torsional spring is a twisting spring.

13. The anti roll bar assembly of claim 8 wherein an inter torque arm width is less than a torsional spring length without bending the torque arms towards each other.

14. A method for controlling unwanted vehicle roll comprising the steps of:
inserting and suspending a torsional spring within a main support tube;
rotatably attaching an over tube at each end of the main support tube;
axially fixing the torsional spring at each end to the over tube so as to inhibit relative motion between the torsional spring and the over tube; and
attaching each torque arm to a vehicle;
wherein each over tube comprises a torque arm fixed to the over tube and an inter torque arm width is less than a torsional spring length without bending the torque arms towards each other.

15. The method of claim 14 wherein the torque arm is slidably fitted and torsional fixed to each over tube so as to inhibit rotative motion between the torque arm and the over tube.
wherein the over tube is axially fixed to the torsional spring using a connection selected from the group consisting of a spline and a male-female geometric shape.

16. The method of claim 14 further comprising a bushing between the over tube and the main support tube.

17. The method of claim 14 further comprising a lubricant placed between the over tube and the main support tube and a seal to maintain the lubricant within the over tube.

18. The method of claim 14 wherein the torque arm is torsionally fixed to the over tube using a connection selected from the group consisting of a spline, a male-female geometric shape, and mating geometric shapes with pinch bolt.

19. The method of claim 14 wherein the torsional spring is a twisting spring.

20. The method of claim 14 wherein each torque arm is integrally formed with the over tube.

21. The method of claim 20 wherein the over tube is axially fixed to the torsional spring using a connection selected from the group consisting of a spline and a male-female geometric shape.

22. The method of claim 14 wherein the torsional spring is a twisting spring.
